(19) United States
(12) Patent Application Publication
(10) Pub. No.: US 2020/0314517 A1
(43) Pub. Date: Oct. 1, 2020

(54) VR MASK SYSTEM AND METHOD

(71) Applicant: Juan Ernesto Souffrain, Cliffside Park, NJ (US)

(72) Inventor: Juan Ernesto Souffrain, Cliffside Park, NJ (US)

(21) Appl. No.: 16/364,812

(22) Filed: Mar. 26, 2019

(51) Int. Cl. H04R 1/10; A42B 1/24; A41D 1/04; A42B 1/00

(52) U.S. Cl. CPC H04R 1/1008; A42B 1/247; A42B 1/245; A41D 1/04; A42B 1/008; H04R 2420/07; H04R 1/1058; H04R 1/1091; H04R 1/1041; A41D 2600/00; H04R 1/105

(57) ABSTRACT

A VR mask system with a mask made from a dry fit material having capacity to move sweat away from a body of a user (via wicking means); the mask having straps for fitting of a VR headset within the mask to ensure the VR headset will not experience relative movement in relation to the mask during use; and a pair of wireless headphones. The headphones rest in between two layers of fabric within the mask. The device is suitable for use with VR systems and equipment.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of garments of existing art and more specifically relates to functional garments.

### RELATED ART

Many people enjoy playing video games. Modernly, virtual reality (VR) is an interactive computer-generated experience taking place within a simulated environment. It may incorporate auditory and visual feedback, but may also allow other types of sensory feedback like haptic. The provided immersive environment can be similar to the real world or it may be ‘fantastical’. Augmented reality systems may also be considered a form of VR that layers virtual information over a live camera feed into a headset or through a smartphone or tablet device giving the user the ability to view three-dimensional images. Headsets may be difficult to wear with conventional clothing.

Current VR technology most commonly uses virtual reality headsets or multi-projected environments, sometimes in combination with physical environments or props, to generate realistic images, sounds and other sensations that simulate a user's physical presence in a virtual or imaginary environment. A person using virtual reality equipment is able to ‘look around’ the artificial world, move around in it, and interact with virtual features or items. The effect is commonly created by VR headsets consisting of a head-mounted display with a small screen in front of the eyes, but can also be created through specially designed rooms with multiple large screens. These rooms may be expensive to design and build. VR systems that include transmission of vibrations and other sensations to the user through a game controller or other devices are known as haptic systems. This tactile information is generally known as force feedback video gaming and training applications.

When using VR goggles for gaming, exercising or any other activity, one of the most common complaints users have is that the VR goggles fall off, move or shift when he/she begins to do movements with the head and or body. Most VR goggles have straps that the user can adjust, but those straps simply hold the VR goggles in place while he/she is using them while sitting or standing with little to no movement. When users begin to move their head more and move their body more while using the VR goggles, the goggles begin to move, shift and often even fall off, making it very uncomfortable to keep adjusting them and putting them back in place. A suitable garment is desired for use with VR systems and equipment.

U.S. Pub. No. 2015/0105129 to Kevin Chapman relates to a video game body suit. The described video game body suit is for use when playing a video game. The video game body suit includes a torso covering, leg coverings, arm coverings, and a headset. Each of the components includes one or more feedback devices thereon, wherein the feedback device may include one or more of a vibration motor, a speaker, a temperature controlling device, and a scent-emitting device. The headset comprises a headband, an earpiece, and a microphone thereon for allowing the user to remotely communicate with other players. The body suit further includes a control circuit that includes a microprocessor and a transceiver capable of wirelessly communicating with a video game console and the various feedback devices. In this way, the video game body suit can provide feedback to the user corresponding to the events that occur within the game.

### SUMMARY OF THE INVENTION

In view of the foregoing disadvantages inherent in the known functional garments art, the present disclosure provides a novel VR mask system, entitled ‘U-NIX VR MASK’. The general purpose of the present disclosure, which will be described subsequently in greater detail, is to provide a comfortable garment efficiently designed for use with VR systems. It should be understood that mask and hood can be used interchangeably and refer to the same head covering means disclosed herein.

The purpose of the present invention is to prevent Virtual reality (VR) goggles from falling off, shifting, or moving in any way when a user is using them and doing any relative movements and/or physical activities. The garment will also provide built in pockets in the ears to install wireless BLUETOOTH headsets for audio in order to eliminate the need to use traditional headsets attached to VR goggles for sound. This mask (garment) can also be used without VR goggles. Users will be able to use the mask to exercise outdoors or to keep warm while in cold environments, thus the present invention is multi-purpose. Hoodie embodiments are also envisioned.

To use this invention, one would simply have to attach the mask to the neck and then wrap the mask over the head and over the VR goggles. Once the mask is on, the user is able to adjust and tighten the mask through the straps for the perfect fit in order to hold the VR goggles securely in place. This will prevent the VR goggles from moving in any way while in use. The same steps are taken in order to use the mask without VR goggles. The mask also comprises at least 2 inside pockets where the ears are with small wireless BLUETOOTH speakers. As adjusted and tightened the mask to the perfect fit, the 2 inside pockets with the speakers in them will comfortably rest on the ears effectively eliminating the need to have any additional devices on the head in order to have audio while using the VR goggles. This VR/Audio mask can be used by anyone using Virtual Reality (VR) goggles for virtually any purpose and can also be used by anyone wanting to wear a hood/hoodie/mask and have built in wireless speakers on the ears.

The problem that the present invention solves is to keep Virtual Reality (VR) goggles from falling off, shifting or moving in any relative way while in use. Once the mask is on, users can adjust and tighten the mask so that the VR goggles don't move in anyway or fall off while users are moving around. The mask has 2 inside pockets where the ears are provided with small wireless BLUETOOTH speakers. As the user adjusts and tightens the mask for the perfect fit, the 2 inside pockets with the speakers in them comfortably rest on the ears eliminating the need to have any additional devices on the head in order to have audio while using the VR goggles.

When used with Virtual Reality (VR) goggles, the user simply puts the mask on and then over the head and over the VR goggles. Then, adjustment(s) can be made and the mask tightened. This prevents the VR goggles from moving. The speakers on the inside of the mask will be resting right on the ears providing audio. When used without Virtual Reality (VR) goggles, simply put the mask on the neck and then over the head. Then adjust and tighten the mask. The speakers on the inside of the mask will be resting right on the ears providing audio.

A VR mask system is disclosed herein, the VR mask system comprising: a dry fit material (preferably sweatshirt fabric) having capacity to move sweat away from a body/neck/head of a user (via wicking means); a mask able to be removably attached to the sweatshirt (if desired); the mask having straps for fitting of a VR headset within the mask to ensure the VR headset will not experience relative movement in relation to the mask during use; and a pair of wireless headphones; the headphones resting in between two layers of fabric within the mask. The described device is suitable for use with VR systems.

In preferred embodiments the mask has three layers (sewn together). The first layer is the inside mask. This first layer touches the user and contains pockets for the speakers and a raceway for wires. It is a dry fit material (sweatshirt material). The second layer is a layer of straps on top of the first layer. These straps adjust the fit of the mask. The third layer is the top layer. This is the visible layer. It too is made of dry-fit material such as sweatshirt material. The preferred embodiment may use a ‘zipper-style’ closure to close the mask about the neck up to the chin. The user pulls the mask over his/her head and the goggles, adjusts the straps and then it is closed up with the zipper (zipping fastener). Other fastening means may be used. A zipping fastener may be used at the rear of the mask at the bottom of the neck area. The ‘zipper’ is located in the area where a normal hood on a hoodie jacket would be sewn in. The VR Mask is able to interface to jackets equipped with the interfacing ‘zipper’.

A method of using a sweatshirt is also described herein, the method comprising the steps of: providing the above-mentioned mask; donning the sweatshirt (if desired and optionally removably coupling the mask to it); and placing a VR headset goggles on a user, and strapping the removable mask completely over the VR headset for use. The method may further comprise the step of donning goggles.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a VR mask system, constructed and operative according to the teachings of the present disclosure.

FIG. 1 is a perspective view of the VR mask system during an ‘in-use’ condition, according to an embodiment of the disclosure.

FIG. 2 is a perspective view of the VR mask system of FIG. 1, according to an embodiment of the present disclosure.

FIG. 3 is another perspective view of the VR mask system of FIG. 1, according to an embodiment of the present disclosure.

FIG. 4 is a perspective view of the VR mask system of FIG. 1, according to an embodiment of the present disclosure.

FIG. 5 is a flow diagram illustrating a method of use for the VR mask system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to functional garments and more particularly to a VR mask system as used to improve the use of VR systems with comfort and a minimum of distraction.

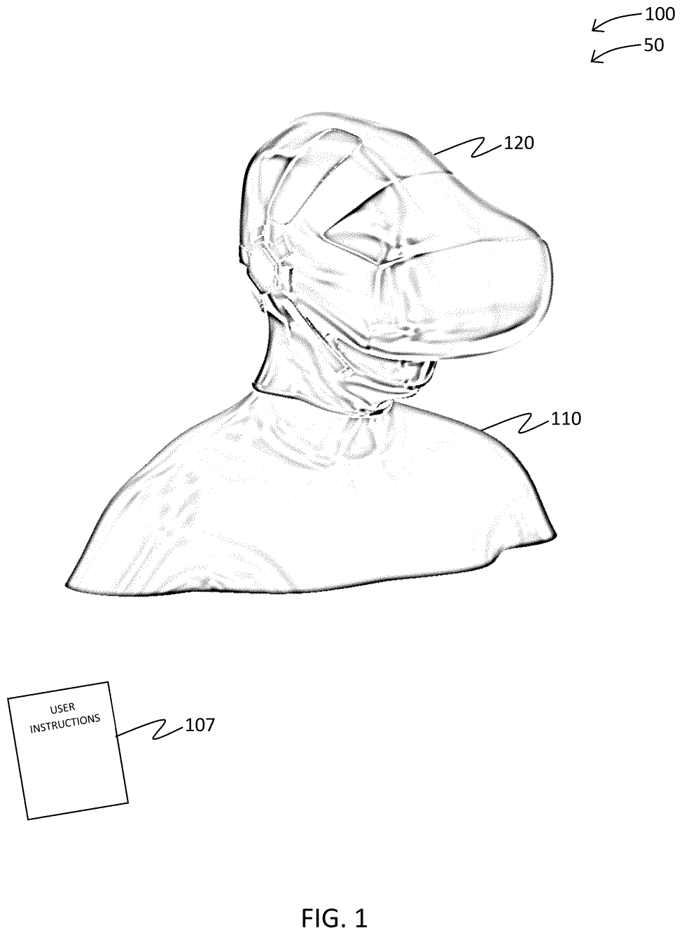

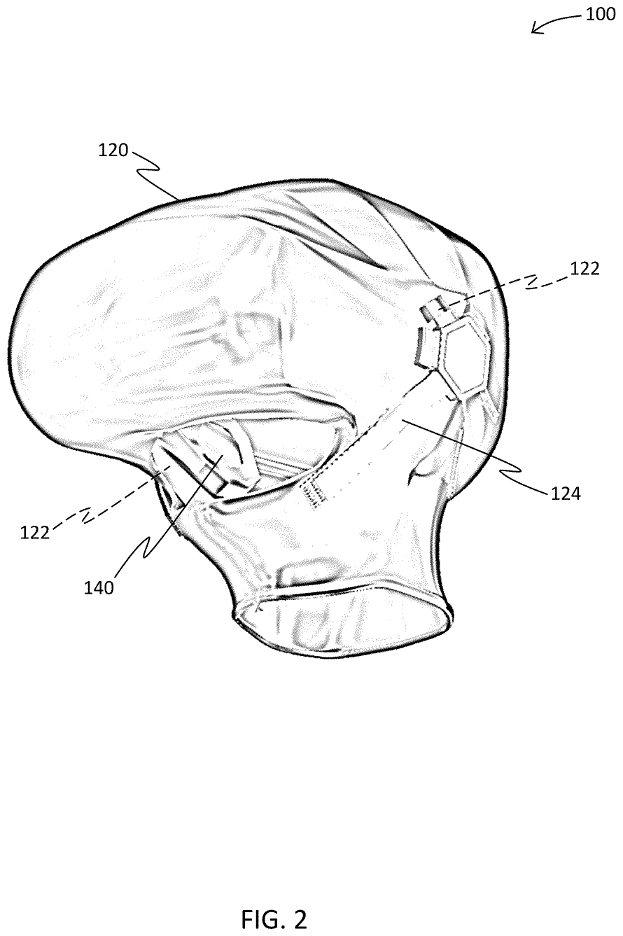

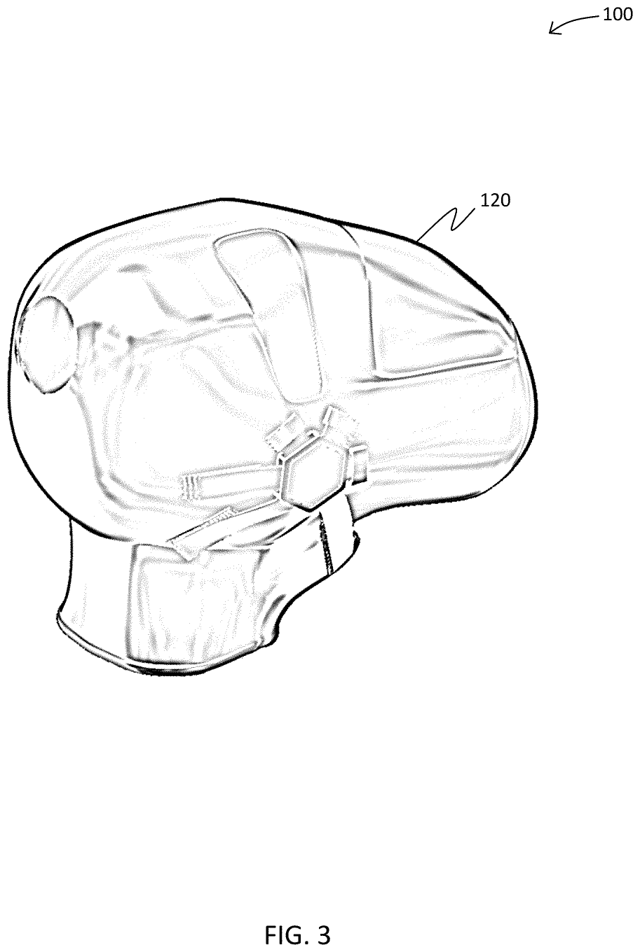

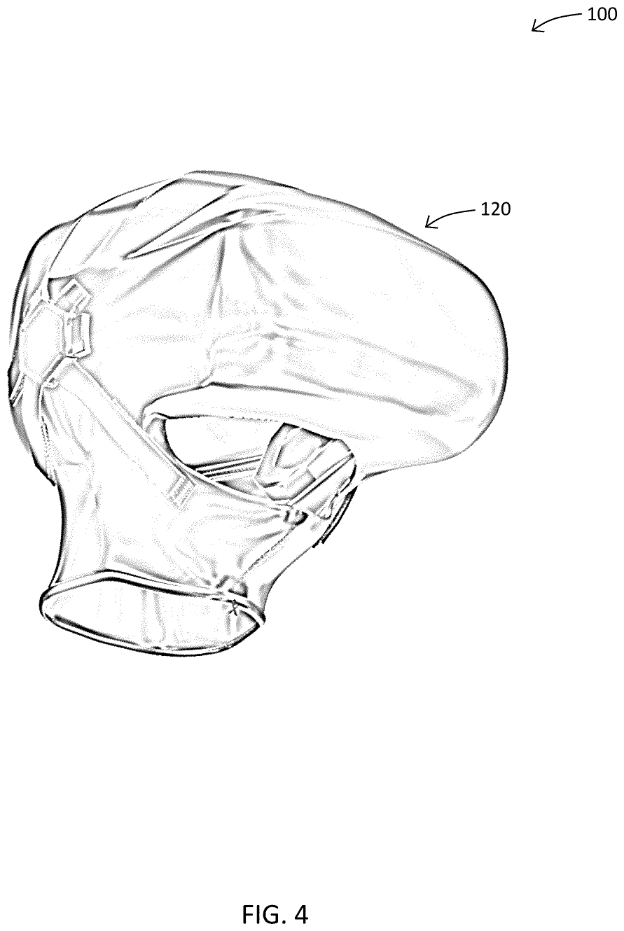

Referring now more specifically to the drawings by numerals of reference, there is shown in FIGS. 1-4, various views of a VR mask system 100.

FIGS. 1-5 show various views of a VR mask system 100 during an ‘in-use’ condition 50 (FIG. 1), according to an embodiment of the present disclosure. Here, the VR mask system 100 may be beneficial for use by a user to comfortably use VR technology (components) and minimize relative movement thereof during the use. As illustrated, the VR mask system 100 may or may not include a sweatshirt 110 (mask 120 may be used in conjunction with a sweatshirt, shirt or no shirt), mask 120 (and the sweatshirt 110 when used) comprising: a dry fit material having capacity to move (wick) sweat away from a body of a user (sweatshirt material or suitable equivalent); the mask 120 able to be removably attached to the sweatshirt 110 (if desired) at the neck area; the mask 120 having straps 130 for fitting of a VR headset within the mask 120 to effectively ensure the VR headset will not experience relative movement in relation to the mask 120 during use (in-use condition 50); and a pair of wireless headphones 140; the headphones 140 resting in between two layers of fabric within the mask 120. In preferred embodiments the mask 120 is configured to completely surround and cover a VR headset and goggles when used (in-use condition 50); wherein the mask 120 and straps 130 are able to be moved behind a head of the user when not in use.

The wireless headphones 140 are able to exchange data over short distances using short-wavelength UHF radio waves in an ISM band from 2.400 to 2.485 GHz (BLUETOOTH) and are positioned to rest comfortably on ears when the mask 120 is adjusted. The wireless headphones 140 may be situated in between two layers of fabric within the pockets 122; wherein the wireless headphones 140 are cushioned to increase comfort. Those with ordinary skill in the art will now appreciate that upon reading this specification and by their understanding the art of BLUETOOTH and other related technology and use as described herein, methods of communication, maintenance and use will be understood by those knowledgeable in such art. As described the present invention provides an equipped shroud. Headsets may be connected to each other inside the mask 120 via a small raceway that connects both speakers in order to keep the wires in place and hidden while the mask 120 is in use.

Referring now again to the mask 120; mask 120 can be removed from the sweatshirt 110 when desired or the sweatshirt 110 may not form part of the system 100; wherein the mask 120 is preferably configured with two pockets 122 on the inside on each side (right and left) of the mask 120. More or less pockets 122 may be employed. The sweatshirt 110 and the mask 120 may be configured to attach and move comfortably during use in particular embodiments. The sweatshirt 110 and the mask 120, as designed (separately or together), are configured to provide warmth for a user in cold temperatures and resist heat transfer via the material it is comprised of; wherein the dry fit material is also configured to allow for the user to exercise while wearing the mask 120 of VR mask system 100.

The straps 124 are designed to adjust (tighten or loosen) the mask 120 to keep the VR goggles in place. During use, the mask 120 preferably completely surrounds the VR headset and goggles. The (wireless) headphones 140 allow the user to use the VR headset and goggles without an additional-headset. The sweatshirt 110 is also configured to be worn as a multi-functional sweatshirt as is the mask 120. As designed, the mask 120 can be attached to the sweatshirt 110 without a VR headset and can be used as a head insulating means.

According to one embodiment, the VR mask system 100 may be arranged as a kit. In particular, the VR mask system 100 may further include a set of instructions 107. The instructions 107 may detail functional relationships in relation to the structure of the VR mask system 100 such that the VR mask system 100 can be used, maintained, or the like, in a preferred manner.

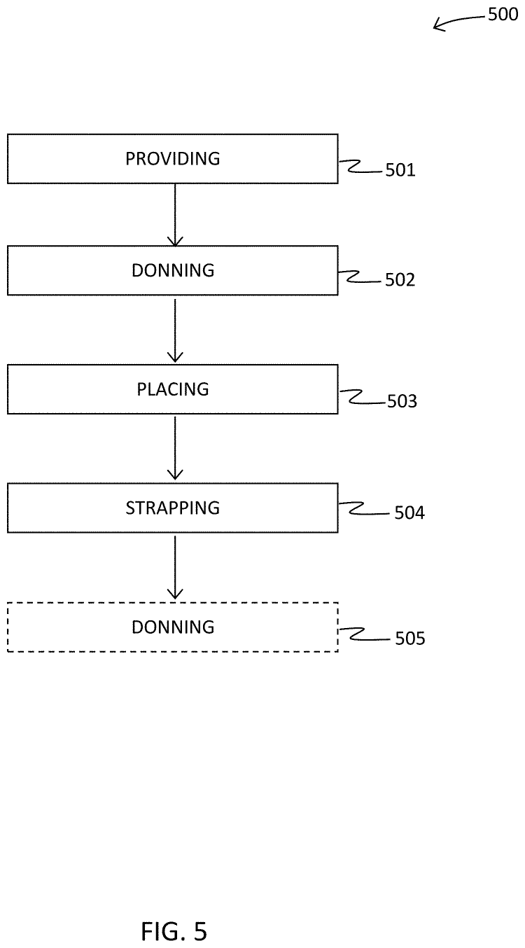

FIG. 5 is a flow diagram illustrating a method for use of VR mask system 100, according to an embodiment of the present disclosure. In particular, the method for use 500 of VR mask system 100 may include one or more components or features of the VR mask system 100 as described above. As illustrated, the method for use 500 may include the steps of: step one 501, providing the above-mentioned sweatshirt (if used), a removable mask, and straps; step two 502, donning the mask; step three 503, placing a VR headset goggles on a use; and step four 504 strapping the removable mask completely over the VR headset for use. The method may further comprise the step five 505 of donning goggles. Adjusting steps may also be included for speaker positioning etc.

It should be noted that step 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, the mask can be attached to other garments such as a sweatshirt or the like, etc., other methods for use and maintenance, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A VR mask system, the VR mask system comprising:
a mask having straps for fitting of a VR headset within the mask to ensure the VR headset will not experience relative movement in relation to the mask during use, said mask made of a dry fit material having capacity to move sweat away from a body of a user;
a pair of wireless headphones, the headphones resting in between at least two layers of fabric within the mask ; and
two pockets disposed opposite to each other on left and right sides of the mask, each pocket being adjacent to an ear of the user when worn, each pocket having a single opening able to accept one of the pair of wireless headphones;
wherein mask is configured to completely surround and cover a VR headset and goggles when the VR headset is being viewed by the user.

2. (canceled)

3. The VR mask system of claim 1, wherein the mask and straps are able to be moved behind a head of the user when not in use.

4. The VR mask system of claim 1, wherein the wireless headphones exchange data over short distances using short-wavelength UHF radio waves in an ISM band from 2.400 to 2.485 GHz and are positioned to rest comfortably on ears when the mask is adjusted.

5. The VR mask system of claim 3, wherein the mask can be removed from a sweatshirt when desired.

6. (canceled)

7. The VR mask system of claim 1, wherein the wireless headphones are situated in between two layers of fabric within the two pockets.

8. The VR mask system of claim 1, wherein the wireless headphones are cushioned to increase comfort.

9. The VR mask system of claim 6, wherein the sweatshirt and the mask are configured to attach and move comfortably.

10. The VR mask system of claim 1, wherein the mask is configured to provide warmth for a user in cold temperatures and resist heat transfer.

11. The VR mask system of claim 1, wherein the dry fit material is also configured to allow for the user to exercise while wearing the mask.

12. The VR mask system of claim 5, further comprising a zipping fastener, wherein the zipping fastener is able to attach the mask to the sweatshirt.

13. (canceled)

14. The VR mask system of claim 1, wherein the headphones allow the user to use the VR headset and goggles without an additional-headset.

15. The VR mask system of claim 1, wherein the mask has a raceway.

16. The VR mask system of claim 1, wherein the mask can be attached to a sweatshirt without a VR headset to be used as a head insulating means.

17. A VR mask system, the VR mask system comprising
a mask having straps for fitting of a VR headset within the mask to ensure the VR headset will not experience relative movement in relation to the mask during use;
a pair of wireless headphones, the headphones resting in between two layers of fabric within the mask;
wherein the mask is configured to completely surround and cover the VR headset and goggles when used;
wherein the mask and straps are able to be moved behind a head of a user when not in use;
wherein the wireless headphones exchanges data over short distances using short-wavelength UHF radio waves in an ISM band from 2.400 to 2.485 GHz and are positioned to rest comfortably on ears when the mask is adjusted;
wherein the mask is configured with two pockets on an inside on each side of the mask;
wherein the headphones are situated in between two layers of fabric within the pockets;
wherein the headphones are cushioned to increase comfort; and
wherein the mask completely surrounds the VR headset and goggles when in use.

18. The VR mask system of claim 17, further comprising set of instructions; and
wherein the mask and the VR mask system is arranged as a kit.

19. A method of using a VR mask system, the method comprising the steps of:
providing a removable mask and straps;
donning the mask; and
placing a VR headset goggles on a user, and strapping the removable mask completely over the VR headset.

20. The method of claim 19, further comprising the step of donning goggles.
